(19) United States
(12) Patent Application Publication
(10) Pub. No.: US 2025/0004182 A1
(43) Pub. Date: Jan. 2, 2025

(54) LIGHT ABSORPTION ANISOTROPIC LAYER, LIGHT ABSORPTION ANISOTROPIC LAYER PRODUCING METHOD, LAMINATE, AND IMAGE DISPLAY DEVICE

(71) Applicant: FUJIFILM Corporation, Tokyo (JP)

(72) Inventors: Toshikazu SUMI, Kanagawa (JP); Naoya NISHIMURA, Kanagawa (JP)

(73) Assignee: FUJIFILM Corporation, Tokyo (JP)

(21) Appl. No.: 18/824,543

(22) Filed: Sep. 4, 2024

Related U.S. Application Data
(63) Continuation of application No. PCT/JP2023/011091, filed on Mar. 22, 2023.

(30) Foreign Application Priority Data
Mar. 29, 2022 (JP) 2022-053411

(51) Int. Cl. G02B 5/00; G02F 1/13363

(52) U.S. Cl. CPC G02B 5/003; G02F 1/133638

(57) ABSTRACT

A light absorption anisotropic layer, manufacturing thereof, a laminate and an image display device. The layer contains a dichroic substance and a liquid crystal compound, in which, when, in an X-ray diffraction pattern measurement using an in-plane diffraction method with X-ray irradiation, diffracted X-rays are measured in a measurement region of a rotation angle φ in in-plane direction of light absorption anisotropic layer: 0° to 180° and a diffraction angle 2θ:0° to 10° to determine a diffraction angle 2θmax and a rotation angle φmax at which a peak intensity is maximized, a peak intensity of diffracted X-rays at the diffraction angle 2θmax and the rotation angle φmax is represented by I(φmax), and a peak intensity of diffracted X-rays at the diffraction angle 2θmax and the rotation angle φmax−10° is represented by I(φmax−10), a relationship expressed by Expression (1) I(φmax)/I(φmax−10)≥1.6 is satisfied.

### CROSS-REFERENCE TO RELATED APPLICATIONS

This application is a Continuation of PCT International Application No. PCT/JP2023/011091 filed on Mar. 22, 2023, which was published under PCT Article 21 (2) in Japanese, and which claims priority under 35 U.S.C. § 119 (a) to Japanese Patent Application No. 2022-053411 filed on Mar. 29, 2022. The above applications are hereby expressly incorporated by reference, in their entirety, into the present application.

### BACKGROUND OF THE INVENTION

### 1. Field of the Invention

The present invention relates to a light absorption anisotropic layer, a light absorption anisotropic layer producing method, a laminate, and an image display device.

### 2. Description of the Related Art

In the related art, devices which are operated by different principles for each function have been used in a case where an attenuation function, a polarization function, a scattering function, a shielding function, or the like is required in relation to irradiated light including laser light and natural light. Therefore, products corresponding to the above-described functions are also produced by production processes different for each function.

For example, a linear polarizer or a circular polarizer is used in an image display device (for example, a liquid crystal display device) to control optical rotation or birefringence in display. Further, a circular polarizer is also used even in an organic light emitting diode (OLED) to prevent reflection of external light.

In the related art, iodine has been widely used as a dichroic substance in these polarizers, but a polarizer that uses an organic coloring agent in place of iodine as a dichroic substance has also been examined.

For example, JP2019-049758A describes a polarizing layer (light absorption anisotropic layer) formed from a composition containing a polymerizable smectic liquid crystal compound and a dichroic coloring agent (see [claim 1]).

### SUMMARY OF THE INVENTION

The present inventors have conducted studies on the light absorption anisotropic layer described in JP2019-049758A, and found that haze occurs and there is room for improvement.

Therefore, an object of the present invention is to provide a light absorption anisotropic layer in which the occurrence of haze is suppressed, a producing method of the light absorption anisotropic layer, and a laminate and an image display device using the light absorption anisotropic layer.

The present inventors have conducted intensive studies to achieve the above-described object, and as a result, they found that a light absorption anisotropic layer in which, in an X-ray diffraction pattern measurement using an in-plane diffraction method, a value of a peak intensity of diffracted X-rays at predetermined positions (two positions) satisfies a specific relationship can suppress the occurrence of haze, and completed the present invention.

That is, the present inventors have found that the object can be achieved with the following configuration.

[1] A light absorption anisotropic layer containing a dichroic substance and a liquid crystal compound,
in which, in a case where, in an X-ray diffraction pattern measurement using an in-plane diffraction method with X-ray irradiation on the light absorption anisotropic layer, diffracted X-rays are measured in a measurement region shown below to determine a diffraction angle 2θmax and a rotation angle φmax at which a peak intensity is maximized, a peak intensity of diffracted X-rays at the diffraction angle 2θmax and the rotation angle φmax is represented by I(φmax), and a peak intensity of diffracted X-rays at the diffraction angle 2θmax and the rotation angle φmax−10° is represented by I(max−10), a relationship expressed by Expression (1) is satisfied.

### Measurement Region:

Rotation angle φ in in-plane direction of light absorption anisotropic layer: 0° to 180°
Diffraction angle 2θ:0° to 10°

$$I ( φ max ) / I ( φmax - 10 ) \geq 1.6 \qquad Expression ( 1 )$$

[2] The light absorption anisotropic layer according to [1], in which, in a case where the light absorption anisotropic layer is fixed at a position of the rotation angle φmax−90° and the diffraction angle 2θ is measured in a range of more than 10° and 30° or less, a peak of diffracted X-rays showing a peak intensity of I(φmax)×0.2 times or more is observed.

[3] The light absorption anisotropic layer according to [1] or [2], in which the light absorption anisotropic layer is formed using a liquid crystal composition containing a dichroic substance, a liquid crystal compound, and a monofunctional compound, and
a molecular length D1 (Å) of the liquid crystal compound in a major axis direction and a molecular length D2 (Å) of the monofunctional compound in a major axis direction satisfy a relationship expressed by Expression (2).

$$0.2 \times D 1 \leq D 2 \leq 0.45 \times D 1 \qquad Expression ( 2 )$$

[4] The light absorption anisotropic layer according to any one of [1] to [3], in which the dichroic substance includes at least two dichroic substances having a maximal absorption wavelength in a wavelength range of 550 to 700 nm.

[5] A light absorption anisotropic layer producing method of producing the light absorption anisotropic layer according to any one of [1] to [4], having:
a light absorption anisotropic layer forming step of irradiating a liquid crystal composition layer containing a dichroic substance, a liquid crystal compound, and a monofunctional compound with ultraviolet rays in air to form a light absorption anisotropic layer.

[6] The light absorption anisotropic layer producing method according to [5], in which the method has a step of irradiating the light absorption anisotropic layer after the light absorption anisotropic layer forming step with ultraviolet rays under nitrogen.

[7] A laminate having: the light absorption anisotropic layer according to any one of [1] to [4]; and a λ/4 plate provided over the light absorption anisotropic layer.

[8] An image display device having: the light absorption anisotropic layer according to any one of [1] to [4] or the laminate according to [7].

According to the present invention, it is possible to provide a light absorption anisotropic layer in which the occurrence of haze is suppressed, a producing method of the light absorption anisotropic layer, and a laminate and an image display device using the light absorption anisotropic layer.

### BRIEF DESCRIPTION OF THE DRAWINGS

FIG. 1 is a schematic conceptual diagram for describing a measurement region in a case where an X-ray diffraction pattern is measured using an in-plane diffraction method for a light absorption anisotropic layer.

### DESCRIPTION OF THE PREFERRED EMBODIMENTS

Hereinafter, the present invention will be described in detail.

The following description of configuration requirements is based on representative embodiments of the present invention, but the present invention is not limited to the embodiments.

In the present specification, a numerical range expressed using “to” means a range including numerical values before and after “to” as a lower limit value and an upper limit value.

In addition, in the present specification, as each component, a substance corresponding to each component may be used alone, or two or more kinds of substances may be used in combination. Here, in a case where two or more kinds of substances are used in combination for each component, the content of the component refers to a total content of the substances used in combination unless otherwise specified.

### [Light Absorption Anisotropic Layer]

A light absorption anisotropic layer according to the embodiment of the present invention is a light absorption anisotropic layer containing a dichroic substance and a liquid crystal compound.

In addition, in the light absorption anisotropic layer according to the embodiment of the present invention, in a case where, in an X-ray diffraction pattern measurement using an in-plane diffraction method with X-ray irradiation, first, diffracted X-rays are measured in a measurement region shown below to determine a diffraction angle 2θmax and a rotation angle φmax at which the peak intensity is maximized, a peak intensity of diffracted X-rays at the diffraction angle 2θmax and the rotation angle φmax is represented by I(φmax), and a peak intensity of diffracted X-rays at the diffraction angle 2θmax and the rotation angle φmax−10° is represented by I(φmax−10), the following relationship expressed by Expression (1) is satisfied. It should be noted that the peak with a maximum peak intensity is also abbreviated as “peak P1”.

### Measurement Region:

Rotation angle φ in in-plane direction of light absorption anisotropic layer: 0° to 180°
Diffraction angle 2θ:0° to 10°

$$I ( φ max ) / I ( φmax - 10 ) \geq 1.6 \qquad Expression ( 1 )$$

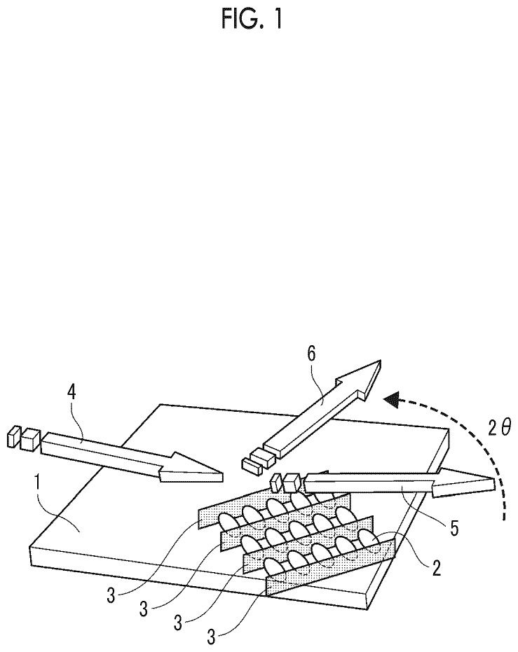

FIG. 1 shows a schematic conceptual diagram for describing a measurement region in a case where an X-ray diffraction pattern is measured using an in-plane diffraction method for the light absorption anisotropic layer.

As shown in FIG. 1, in the measurement of the X-ray diffraction pattern using the in-plane diffraction method, incident X-rays 4 are made incident at an incidence angle substantially parallel (more than 0° and 1° or less) to a surface of a light absorption anisotropic layer 1, and a diffraction angle 2θ (an angle formed between reflected X-rays 5 and the diffracted X-rays) of diffracted X-rays 6 is measured with a detector to evaluate the regularity of the arrangement structure (diffraction plane 2) of a liquid crystal compound 2.

In the present invention, in the above-described measurement of the diffracted X-rays in the measurement region, the value of a peak intensity measured under the following conditions is employed. In the above-described measurement of the diffracted X-rays in the measurement region, in a state in which the rotation angle φ in the in-plane direction of the light absorption anisotropic layer is fixed at any angle between 0° to 180°, the measurement range (0° to) 10° of the diffraction angle 2θ may be measured at an interval of 0.008°, and in a state in which the measurement range of the diffraction angle 2θ is fixed at any angle between 0° to 10°, the rotation angle q (0° to) 180° in the in-plane direction of the light absorption anisotropic layer may be measured at an interval of 1°.

### <Measurement Conditions>

Source of Incident X-rays: CuKα rays

Reference) (0° position of rotation angle φ: the position of the light absorption anisotropic layer in a case where the X-rays are first incident

Reference) (180° position of rotation angle φ: the position where the light absorption anisotropic layer is rotated by 180° clockwise from the position of 0°

Measurement interval of rotation angle φ: 1°

Measurement interval of diffraction angle 2θ:0.008°

In the light absorption anisotropic layer according to the embodiment of the present invention, as described above, in a case where Expression (1) is satisfied in the X-ray diffraction pattern measurement using the in-plane diffraction method, the occurrence of haze can be suppressed.

The reason why this effect is exhibited is not clear in detail, but the present inventors have presumed as follows.

First, in the X-ray diffraction pattern measurement using the in-plane diffraction method, as described above, the light absorption anisotropic layer is rotated to a predetermined position in the in-plane direction, and the diffraction angle 2θ of the diffracted X-rays is measured with a detector to evaluate the regularity of the structure.

Therefore, depending on the rotation position of the light absorption anisotropic layer, the presence of a regular structure in which the incident X-rays are not diffracted (that is, the disorder of the alignment of the liquid crystal compound) cannot be correctly evaluated. The present inventers surmise that the disorder of the alignment of the liquid crystal compound causes the occurrence of haze in the light absorption anisotropic layer.

Regarding this, in the present invention, it is considered that, in a case where I(φmax-10) at a position where only the rotation angle is shifted by 10° is also measured from the rotation angle and the diffraction angle at which the maximum intensity I(φmax) is shown, and I(φmax) and I(φmax−10) satisfy Expression (1), that is, I(φmax−10) derived from a regular structure due to the disorder of the alignment of the liquid crystal compound is sufficiently small, the occurrence of haze of the light absorption anisotropic layer is suppressed.

In the present invention, since the occurrence of haze is further suppressed, it is preferable that, in a case where the light absorption anisotropic layer is fixed at a position of the rotation angle ϕmax−90° (that is, a position where the light absorption anisotropic layer is rotated by 90° counterclockwise from the position of rotation angle φmax) and the diffraction angle 2θ is measured in a range of more than 10° and 30° or less, a peak (hereinafter, also abbreviated to as “peak P2”) of diffracted X-rays showing a peak intensity of I(φmax)×0.2 times or more be observed. In the measurement of the diffracted X-rays of the peak P2, the value of a peak intensity measured under the following conditions is employed.

### <Measurement Conditions>

Source of Incident X-rays: CuKα rays

Measurement interval of diffraction angle 2θ:0.008°

As described above, the light absorption anisotropic layer according to the embodiment of the present invention is preferably a light absorption anisotropic layer containing a dichroic substance and a liquid crystal compound, and a layer in which alignment states of the liquid crystal compound and the dichroic substance are fixed.

Hereinafter, the dichroic substance, liquid crystal compound, and optional components contained in the light absorption anisotropic layer according to the embodiment of the present invention will be described.

### <Dichroic Substance>

In the present invention, the dichroic substance means a coloring agent having different absorbances depending on directions. The dichroic substance may or may not exhibit liquid crystallinity.

The dichroic substance is not particularly limited, and examples thereof include a visible light absorbing substance (dichroic coloring agent), a light emitting substance (fluorescent substance and phosphorescent substance), an ultraviolet absorbing substance, an infrared absorbing substance, a non-linear optical substance, a carbon nanotube, and an inorganic substance (for example, quantum rod). Further, dichroic substances (dichroic coloring agents) known in the related art can be used.

Specific examples thereof include those described in paragraphs [0067] to [0071] of JP2013-228706A, paragraphs [0008] to [0026] of JP2013-227532A, paragraphs [0008] to [0015] of JP2013-209367A, paragraphs [0045] to [0058] of JP2013-14883A, paragraphs [0012] to [0029] of JP2013-109090A, paragraphs [0009] to [0017] of JP2013-101328A, paragraphs [0051] to [0065] of JP2013-37353A, paragraphs [0049] to [0073] of JP2012-63387A, paragraphs [0016] to [0018] of JP1999-305036A (JP-H11-305036A), paragraphs [0009] to [0011] of JP2001-133630A, paragraphs [0030] to [0169] of JP2011-215337A, paragraphs [0021] to [0075] of JP2010-106242A, paragraphs [0011] to [0025] of JP2010-215846A, paragraphs [0017] to [0069] of JP2011-048311A, paragraphs [0013] to [0133] of JP2011-213610A, paragraphs [0074] to [0246] of JP2011-237513A, paragraphs [0005] to [0051] of JP2016-006502A, paragraphs [0014] to [0032] of JP2018-053167A, paragraphs [0014] to [0033] of JP2020-11716A, paragraphs [0005] to [0041] of WO2016/060173A, paragraphs [0008] to [0062] of WO2016/136561A, paragraphs [0014] to [0033] of WO2017/154835A, paragraphs [0014] to [0033] of WO2017/154695A, paragraphs [0013] to [0037] of WO2017/195833A, paragraphs [0014] to [0034] of WO2018/164252A, paragraphs [0021] to [0030] of WO2018/186503A, paragraphs [0043] to [0063] of WO2019/189345A, paragraphs [0043] to [0085] of WO2019/225468A, paragraphs [0050] to [0074] of WO2020/004106A, and paragraphs [0015] to [0038] of WO2021/044843A.

As the dichroic substance, a dichroic azo coloring agent compound is preferable.

The dichroic azo coloring agent compound means an azo coloring agent compound having different absorbances depending on directions. The dichroic azo coloring agent compound may or may not exhibit liquid crystallinity. In a case where the dichroic azo coloring agent compound exhibits liquid crystallinity, it may exhibit any of nematic properties or smectic properties may be exhibited. The temperature range in which the liquid crystal phase is exhibited is preferably room temperature (approximately 20° C. to 28° C.) to 300° C., and from the viewpoint of handleability and production suitability, more preferably 50° C. to 200° C.

In the present invention, since it is possible to suppress the precipitability of the dichroic substance in a case where a composition for forming a light absorption anisotropic layer to be described later is subjected to a lapse of time, at least two dichroic substances having a maximal absorption wavelength in a wavelength range of 550 to 700 nm are preferably used.

The upper limit of the content of the dichroic substance contained in the light absorption anisotropic layer is preferably 30% by mass or less, more preferably 20% by mass or less, and still more preferably 15% by mass or less with respect to the total mass of the light absorption anisotropic layer. In addition, the lower limit thereof is preferably 0.1% by mass or more, more preferably 1% by mass or more, and still more preferably 3% by mass or more.

In addition, the content of the dichroic substance contained in the light absorption anisotropic layer is preferably 20 to 400 mg/cm³, more preferably 30 to 200 mg/cm³, and still more preferably 40 to 150 mg/cm³, since the alignment degree of the light absorption anisotropic layer to be formed is increased. In a case where a plurality of dichroic substances are used in combination, the total amount of the plurality of dichroic substances is preferably within the above range.

Here, the content (mg/cm³) of the dichroic substance is obtained by measuring a solution, obtained by dissolving a laminate having the light absorption anisotropic layer, or an extraction liquid, obtained by immersing an optical laminate in a solvent, using high performance liquid chromatography (HPLC), but the measurement method is not limited to the above-described method. In addition, the quantification can be performed by using the dichroic substance contained in the light absorption anisotropic layer as a standard sample. In addition, examples of the method of calculating the content of the dichroic substance include a method in which the volume is calculated by multiplying the thickness of the light absorption anisotropic layer obtained from a microscopic observation image of a cross section of the laminate by the area of the laminate used for measuring the coloring agent amount, and is divided by the coloring agent amount measured by HPLC to calculate the content of the coloring agent.

### <Liquid Crystal Compound>

As the liquid crystal compound contained in the light absorption anisotropic layer, any of a polymer liquid crystal compound or a low-molecular-weight liquid crystal compound can be used.

Here, the “polymer liquid crystal compound” refers to a liquid crystal compound having a repeating unit in the chemical structure.

In addition, the “low-molecular-weight liquid crystal compound” refers to a liquid crystal compound having no repeating unit in the chemical structure.

Examples of the polymer liquid crystal compound include thermotropic liquid crystal polymers described in JP2011-237513A and polymer liquid crystal compounds described in paragraphs to of WO2018/199096A.

Examples of the low-molecular-weight liquid crystal compound include liquid crystal compounds described in paragraphs [0072] to [0088] of JP2013-228706A. Among these, a smectic liquid crystal compound is preferable.

Examples of such a liquid crystal compound include those described in paragraphs to of WO2022/014340A, the description of which is incorporated herein by reference.

In the present invention, the liquid crystal compound contained in the light absorption anisotropic layer is preferably a liquid crystal compound exhibiting a liquid crystal state of a smectic phase (hereinafter, also abbreviated as “smectic liquid crystal compound”).

Here, examples of the smectic phase include a smectic A phase and a smectic C phase, and a higher-order smectic phase (such as a smectic B phase, a smectic E phase, a smectic F phase, a smectic G phase, a smectic H phase, a smectic I phase, a smectic J phase, a smectic K phase, and a smectic L phase) may also be employed.

In addition, the liquid crystal compound may exhibit a nematic phase in addition to the smectic phase.

In addition, in the present invention, since the alignment degree of the light absorption anisotropic layer is improved, the liquid crystal compound is preferably a liquid crystal compound exhibiting a liquid crystal state of any of a smectic B phase, a smectic E phase, a smectic F phase, a smectic G phase, a smectic H phase, a smectic I phase, a smectic J phase, a smectic K phase, or a smectic L phase.

As the smectic liquid crystal compound, a compound represented by Formula (I) or (II) is preferable, and it is more preferable to use a compound represented by Formula (I) and a compound represented by Formula (II) in combination.

Q1-V1-SP1-X1-(Ma-La)na-X2-SP2-V2-Q2 Formula (I)

Q1-V1-SP1-X1-(Ma-La)na-Q3 Formula (II)

In Formulae (I) and (II), Q1 and Q2 each independently represent a polymerizable group, and Q3 represents a hydrogen atom or a substituent.

In addition, V1, V2, X1, and X2 each independently represent a single bond or a divalent linking group.

In addition, SP1 and SP2 each independently represent a divalent spacer group.

In addition, na represents an integer of 2 to 10.

In addition, Ma represents an aromatic ring, an aliphatic ring, or a heterocyclic ring, which may have a substituent. Here, a plurality of Ma's may be the same or different from each other.

In addition, La represents a single bond or a divalent linking group. Here, a plurality of La's may be the same or different from each other.

As the polymerizable group represented by one aspect of Q1 and Q2, a polymerizable group which is radically polymerizable (radically polymerizable group) or a polymerizable group which is cationically polymerizable (cationically polymerizable group) is preferable.

A known radically polymerizable group can be used as the radically polymerizable group, and suitable examples thereof include an acryloyloxy group and a methacryloyloxy group. In this case, it is known that the acryloyloxy group generally has a high polymerization rate, and from the viewpoint of improving productivity, the acryloyloxy group is preferable. However, the methacryloyloxy group can also be used as the polymerizable group.

A known cationically polymerizable group can be used as the cationically polymerizable group, and specific examples thereof include an alicyclic ether group, a cyclic acetal group, a cyclic lactone group, a cyclic thioether group, a spiro orthoester group, and a vinyloxy group. Among these, an alicyclic ether group or a vinyloxy group is suitable, and an epoxy group, an oxetanyl group, or a vinyloxy group is particularly preferable.

Particularly preferable examples of the polymerizable group include a polymerizable group represented by any of Formulae (P-1) to (P-20).

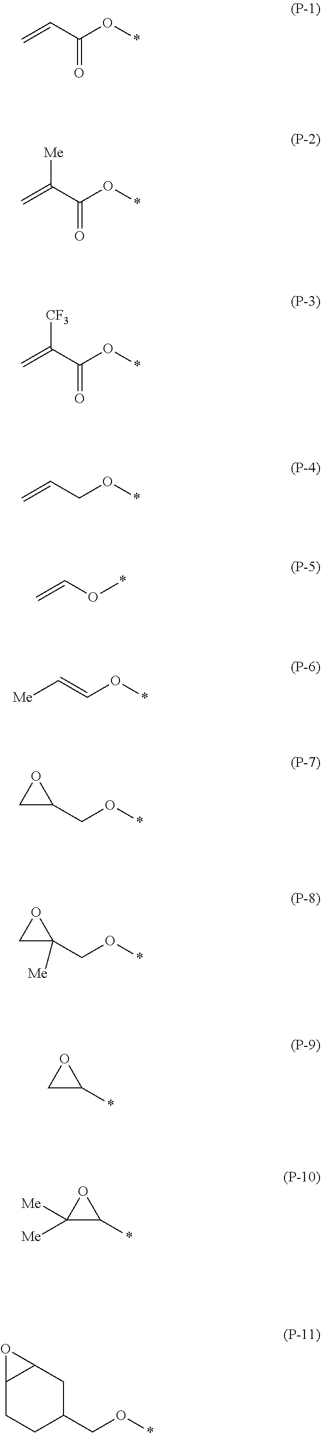

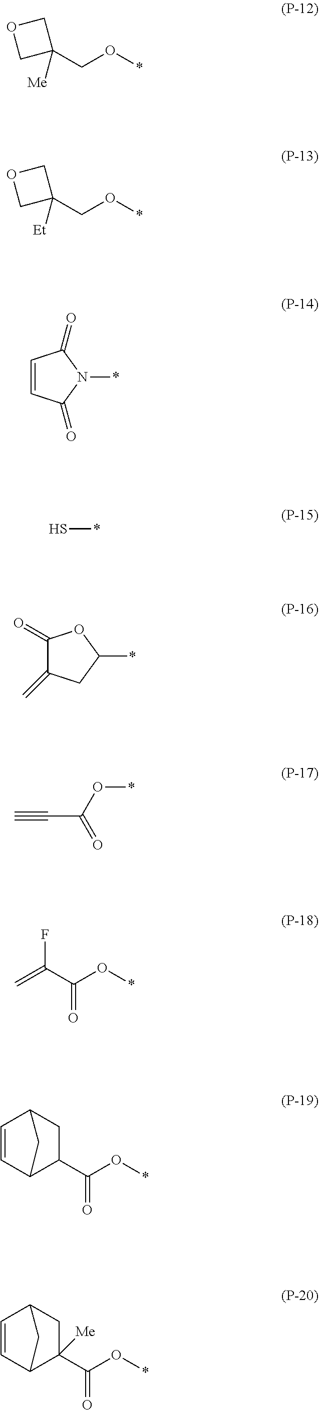

In Formulae (I) and (II), examples of the divalent linking group represented by one aspect of V1, V2, X1, X2, and La include —O—, —(CH₂)_{g}—, —(CF₂)_{g}—, —Si(CH₃)₂—, —(Si(CH₃)₂O)_{g}—, —(OSi(CH₃)₂)_{g}— [g represents an integer of 1 to 10], —N(Z)—, —C(Z)═C(Z′)—, —C(Z)═N—, —N═C(Z)—, —C(Z)₂—C(Z′)₂—, —C(O)—, —OC(O)—, —C(O)O—, —O—C(O)O—, —N(Z) C(O)—, —C(O) N(Z)—, —C(Z)═C(Z′)—C(O)O—, —O—C(O)—C(Z)—C(Z′)—, —C(Z)═N—, —N═C(Z)—, —C(Z)═C(Z′)—C(O) N(Z″)—, —N(Z″)—C(O)—C(Z)═C(Z′)—, —C(Z)═C(Z′)—C(O)—S—, —S—C(O)—C(Z)═C(Z′)—, —C(Z)═N—N═C(Z′)—[Z, Z′, and Z″ each independently represent a hydrogen atom, an alkyl group having 1 to 4 carbon atoms, a cycloalkyl group, an aryl group, a cyano group, or a halogen atom], —C≡C—, —N═N—, —S—, —S(O)—, —S(O)(O)—, —(O)S(O)O—, —O(O)S(O)O—, —SC(O)—, and —C(O)S—. V1, V2, X1, X2, and La may be a group obtained by combining two or more of the above groups.

Among the divalent linking groups, —CO—, —O—, —S—, —C(═S)—, —C(Z)(Z′)—, —C(Z)—C(Z′)—, —N(Z)—, or a divalent linking group consisting of a combination of two or more of the above groups is preferable.

In Formulae (I) and (II), examples of the divalent spacer group represented by SP1 and SP2 include a linear, branched, or cyclic alkylene group having 1 to 50 carbon atoms and a heterocyclic group having 1 to 20 carbon atoms.

The carbon atoms of the alkylene group and the carbon atoms of the heterocyclic group may be substituted with —O—, —Si(CH₃)₂—, —(Si(CH₃)₂O)_{g}—(OSi(CH₃)₂)_{g}— [g represents an integer of 1 to 10], —N(Z)—, —C(Z)═C(Z′)—, —C(Z)═N—, —N═C(Z)—, —C(Z) 2-C(Z′)₂—, —C(O)—, —OC(O)—, —C(O)O—, —O—C(O)O—, —N(Z) C(O)—, —C(O) N(Z)—, —C(Z)═C(Z′)—C(O)O—, —O—C(O)—C(Z)—C(Z′)—, —C(Z)≡N—, —N═C(Z)—, —C(Z)—C(Z′)—C(O)N(Z″)—, —N(Z″)—C(O)—C(Z)═C(Z′)—, —C(Z)═C(Z′)—C(O)—S—, —S—C(O)—C(Z)—C(Z′)—, —C(Z)═N—N═C(Z′)— [Z, Z′, and Z″ each independently represent a hydrogen atom, an alkyl group having 1 to 4 carbon atoms, a cycloalkyl group, an aryl group, a cyano group, or a halogen atom], —C≡C—, —N═N—, —S—, —C(S)—, —S(O)—, —SO₂—, —(O)S(O)O—, —O(O)S(O)O—, —SC(O)—, —C(O)S—, or a group obtained by combining two or more of the above groups.

Further, the hydrogen atoms of the alkylene group and the hydrogen atoms of the heterocyclic group may be substituted with a halogen atom, a cyano group, —Z^{H}, —OH, —OZ″, —COOH, —C(O)Z^{H}, —C(O)OZ^{H}, —OC(O)Z^{H}, —OC(O)OZ^{H}, —NZ^{H}Z_{H}, —NZ^{H}C(O)Z^{H}, —NZ^{H}C(O)OZ^{H}, —C(O)NZ^{H}Z^{H}, —OC(O)NZ^{H}Z^{H}, —NZ^{H}C(O)NZ^{H}OZ^{H}, —SH, —SZ^{H}, —C(S)Z^{H}, —C(O)SZ^{H}, or —SC(O)Z^{H}. Here, Z^{H}, Z^{H}′, and Z″ each independently represent an alkyl group having 1 to 10 carbon atoms, a halogenated alkyl group, or -L-Q [L represents a single bond or a divalent linking group, specific examples of the divalent linking group are the same as those for V1 described above, Q represents a crosslinkable group, examples of suitable aspects of Q1 or Q2 include polymerizable groups, and a polymerizable group represented by any of Formulae (P-1) to (P-20) is preferable].

Further, as the divalent spacer group represented by SP1 and SP2, a linear alkylene group having 1 to 12 carbon atoms, a branched alkylene group having 3 to 12 carbon atoms, or a divalent linking group in which one or more —CH₂—'s constituting these alkylene groups have been substituted with —O—, —S—, —NH—, —N(Z)—, or —CO— is preferable.

In Formulae (I) and (II), Ma represents an aromatic ring, an aliphatic ring, or a heterocyclic ring, which may have a substituent, and is preferably a 4- to 15-membered ring. Ma may be a monocyclic ring or a fused ring, and a plurality of MA's may be the same or different from each other.

Examples of the aromatic ring represented by Ma include a phenylene group, a naphthylene group, a fluorene-diyl group, an anthracene-diyl group, and a tetracene-diyl group. From the viewpoint of design diversity of the mesogenic skeleton and the availability of raw materials, a phenylene group or a naphthylene group is preferable.

Examples of the aliphatic ring represented by Ma include a cyclopentylene group and a cyclohexylene group, and the carbon atoms thereof may be substituted with —O—, —Si(CH₃)₂—, —N(Z)—[Z represents a hydrogen atom, an alkyl group having 1 to 4 carbon atoms, a cycloalkyl group, an aryl group, a cyano group, or a halogen atom], —C(O)—, —S—, —C(S)—, —S(O)—, —SO₂—, or a group obtained by combining two or more of the above groups.

Examples of the atoms other than carbon atoms constituting the heterocyclic ring represented by Ma include a nitrogen atom, a sulfur atom, and an oxygen atom. In a case where the heterocyclic ring has a plurality of atoms other than carbon, constituting a ring, these atoms may be the same or different from each other. Specific examples of the heterocycle include a pyridylene group (pyridine-diyl group), a pyridazine-diyl group, an imidazole-diyl group, a thienylene group (thiophene-diyl group), a quinolylene group (quinoline-diyl group), an isoquinolylene group (isoquinoline-diyl group), an oxazole-diyl group, a thiazole-diyl group, an oxadiazole-diyl group, a benzothiazole-diyl group, a benzothiadiazole-diyl group, a phthalimido-diyl group, a thienothiazole-diyl group, a thiazolothiazole-diyl group, a thienothiophene-diyl group, a thienooxazole-diyl group, and the following structures (II-1) to (II-4).

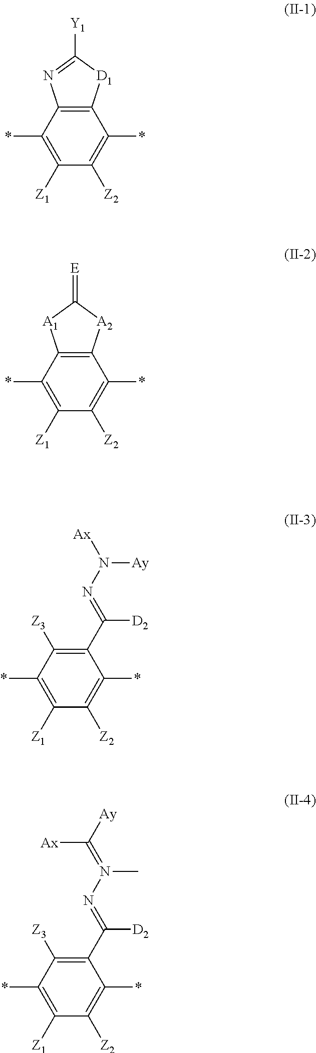

In Formulae (II-1) to (II-4), D₁ represents —S—, —O—, or NR¹¹—, and R¹¹ represents a hydrogen atom or an alkyl group having 1 to 6 carbon atoms.

Y₁ represents an aromatic hydrocarbon group having 6 to 12 carbon atoms or an aromatic heterocyclic group having 3 to 12 carbon atoms.

Z₁, Z₂, and Z₃ each independently represent a hydrogen atom, an aliphatic hydrocarbon group having 1 to 20 carbon atoms, an alicyclic hydrocarbon group having 3 to 20 carbon atoms, a monovalent aromatic hydrocarbon group having 6 to 20 carbon atoms, a halogen atom, a cyano group, a nitro group, —NR¹²R¹³, or SR¹². Here, Z¹ and Z² may be bonded to each other to form an aromatic ring or an aromatic heterocyclic ring, and R¹² and R¹³ each independently represent a hydrogen atom or an alkyl group having 1 to 6 carbon atoms.

A₁ and A₂ each independently represent a group selected from the group consisting of —O—, —NR²¹—(R²¹ represents a hydrogen atom or a substituent), —S—, and —CO—.

E represents a non-metal atom of a Group 14 to a Group 16, to which a hydrogen atom or a substituent may be bonded.

Ax represents an organic group having 2 to 30 carbon atoms, which has at least one aromatic ring selected from the group consisting of an aromatic hydrocarbon ring and an aromatic heterocyclic ring.

Ay represents a hydrogen atom, an alkyl group having 1 to 6 carbon atoms, which may have a substituent, or an organic group having 2 to 30 carbon atoms, which has at least one aromatic ring selected from the group consisting of an aromatic hydrocarbon ring and an aromatic heterocyclic ring, in which the aromatic rings of Ax and Ay may have a substituent and Ax and Ay may be bonded to each other to form a ring.

D₂ represents a hydrogen atom or an alkyl group having 1 to 6 carbon atoms, which may have a substituent.

In Formula (II-2), in a case where Y1 represents an aromatic hydrocarbon group having 6 to 12 carbon atoms, the aromatic hydrocarbon group may be monocyclic or polycyclic. In a case where Y₁ represents an aromatic heterocyclic group having 3 to 12 carbon atoms, the aromatic heterocyclic group may be monocyclic or polycyclic.

In Formula (II-2), in a case where A₁ and A₂ represent —NR²¹—, the substituent as R²¹ can refer to, for example, the description in paragraphs to of JP2008-107767A, and the content thereof is incorporated in the present specification.

In Formula (II-2), in a case where X represents a non-metal atom of Group 14 to Group 16, to which a substituent may be bonded, ═O, ═S, ═NR′, or ═C(R′)R′ is preferable. R′ represents a substituent. The substituent can refer to, for example, the description in paragraphs to of JP2008-107767A, and a nitrogen atom is preferable.

Examples of the substituent which may be included in an aromatic ring, an aliphatic ring, or a heterocyclic ring as Ma in Formulae (I) and (II) include a halogen atom, an alkyl group having 1 to 20 carbon atoms, a halogenated alkyl group having 1 to 20 carbon atoms, a cycloalkyl group having 1 to 20 carbon atoms, an alkoxy group having 1 to 20 carbon atoms, an alkenyl group having 1 to 20 carbon atoms, an alkynyl group having 1 to 20 carbon atoms, an aryl group having 1 to 20 carbon atoms, a heterocyclic group, a cyano group, a hydroxy group, a nitro group, a carboxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heterocyclic thio group, a sulfamoyl group, a sulfo group, an alkyl or arylsulfinyl group, an alkyl or arylsulfonyl group, an acyl group, an aryloxycarbonyl group, an alkoxycarbonyl group, a carbamoyl group, an aryl or heterocyclic azo group, an imide group, a phosphino group, a phosphinyl group, a phosphinyloxy group, a phosphinylamino group, a phosphono group, a silyl group, a hydrazino group, a ureido group, a boronic acid group (—B(OH)₂), a phosphate group (—OPO(OH)₂), a sulfate group (—OSO₃H), and other known substituents.

Details of the substituent are described in paragraph of JP2007-234651A.

In Formulae (I) and (II), na represents an integer of 2 to 10, preferably an integer of 2 to 8, and more preferably an integer of 2 to 5.

In Formula (II), examples of the substituent represented by one aspect of Q3 include the same substituents as those in the description of Ma in Formula (I), which may be included in an aromatic ring, an aliphatic ring, or a heterocyclic ring. Among these, an alkyl group having 1 to 20 carbon atoms or an alkoxy group having 1 to 20 carbon atoms is preferable.

Examples of the smectic liquid crystal compound include those described in paragraphs to of JP2008-19240A, paragraphs to of JP2008-214269A, and paragraphs to of JP2006-215437A, the description of which is incorporated herein by reference.

In the present invention, the content of the liquid crystal compound is preferably 50% to 99% by mass, and more preferably 75% to 95% by mass with respect to the total mass of the light absorption anisotropic layer.

### <Liquid Crystal Composition>

The light absorption anisotropic layer according to the embodiment of the present invention is preferably formed using a liquid crystal composition (hereinafter, also abbreviated as “composition for forming a light absorption anisotropic layer”) containing the dichroic substance and the liquid crystal compound described above.

### (Monofunctional Compound)

Since the occurrence of haze is further suppressed, the composition for forming a light absorption anisotropic layer preferably contains a monofunctional compound satisfying the relationship expressed by Expression (2) in association with the relationship with the above-described liquid crystal compound. That is, a molecular length D1 (Å) of the above-described liquid crystal compound in a major axis direction and a molecular length D2 (Å) of the monofunctional compound in a major axis direction preferably satisfy the relationship expressed by Expression (2). It is considered that by satisfying Expression (2), a free volume is created between the molecules of the liquid crystal compound, the presence of the free volume can suppress the disorder of the alignment that may occur in the curing of the composition for forming a light absorption anisotropic layer, and as a result, the occurrence of haze can be further suppressed.

$$0.2 \times D 1 \leq D 2 \leq 0.45 \times D 1 \qquad Expression ( 2 )$$

Here, the molecular length D1 (Å) in the major axis direction of the liquid crystal compound and the molecular length D2 (Å) in the major axis direction of the monofunctional compound are values calculated by the following procedure.
(1) A structure of a compound (target compound) to be calculated is specified.
(2) A ChemDraw file in which a chemical formula of the target compound has been created is saved in an “MDL Molfile format”.
(3) The saved MDL Molfile format file is opened with an application for molecular modeling (for example, Winmostar) to carry out the structure optimization by a simple molecular force field method.
(4) An interatomic distance at both terminals of the target compound after the structure optimization is calculated as a molecular length.

Such a monofunctional compound is preferably a non-liquid crystal compound, more preferably a compound having a polymerizable group, and still more preferably a compound having a polymerizable group and having a molecular weight of 500 or less.

Here, examples of the polymerizable group include the same polymerizable groups as those in the description of Q1 in Formula (I), and suitable examples thereof include a polymerizable group represented by any of Formulae (P-1) to (P-20).

### (Solvent)

From the viewpoint of workability, the composition for forming a light absorption anisotropic layer preferably contains a solvent.

Examples of the solvent include organic solvents such as ketones, ethers, aliphatic hydrocarbons, alicyclic hydrocarbons, aromatic hydrocarbons, carbon halides, esters, alcohols, cellosolves, cellosolve acetates, sulfoxides, amides, and heterocyclic compounds, and water.

These solvents may be used alone or in combination of two or more kinds thereof.

Among these solvents, organic solvents are preferable, and carbon halides or ketones are more preferable.

In a case where the composition for forming a light absorption anisotropic layer contains a solvent, the content of the solvent is preferably 80% to 99% by mass, more preferably 83% to 97% by mass, and still more preferably 85% to 95% by mass with respect to the total mass of the composition for forming a light absorption anisotropic layer.

### (Polymerization Initiator)

The composition for forming a light absorption anisotropic layer may contain a polymerization initiator.

The polymerization initiator is not particularly limited, but a photosensitive compound, that is, a photopolymerization initiator is preferable.

Commercially available products can also be used as such a photopolymerization initiator, and examples thereof include IRGACURE 184, IRGACURE 907, IRGACURE 369, IRGACURE 651, IRGACURE 819, IRGACURE OXE-01, and IRGACURE OXE-02, manufactured by BASF SE.

The polymerization initiators may be used alone or in combination of two or more kinds thereof.

In a case where the composition for forming a light absorption anisotropic layer contains a polymerization initiator, the content of the polymerization initiator is preferably 0.01% to 30% by mass, and more preferably 0.1% to 15% by mass with respect to the total solid content of the composition for forming a light absorption anisotropic layer.

### [Light Absorption Anisotropic Layer Producing Method]

A light absorption anisotropic layer producing method according to the embodiment of the present invention is a producing method of the above-described light absorption anisotropic layer according to the embodiment of the present invention, having a light absorption anisotropic layer forming step of irradiating a liquid crystal composition layer containing a dichroic substance, a liquid crystal compound, and a monofunctional compound with ultraviolet rays (UV) in the air to form a light absorption anisotropic layer.

Here, the “liquid crystal composition layer containing a dichroic substance, a liquid crystal compound, and a monofunctional compound” is not particularly limited as long as it is a liquid crystal composition layer formed using a liquid crystal composition (a composition for forming a light absorption anisotropic layer) containing the dichroic substance, the liquid crystal compound, and the monofunctional compound described above, and examples thereof include a coating film formed by applying the above-described composition for forming a light absorption anisotropic layer to an alignment film to be described later.

Examples of the method of applying the composition for forming a light absorption anisotropic layer include known methods such as a roll coating method, a gravure printing method, a spin coating method, a wire bar coating method, an extrusion coating method, a direct gravure coating method, a reverse gravure coating method, a die coating method, a spraying method, and an ink jet method.

The alignment film may be any film as long as it is a film in which the liquid crystal component which can be contained in the composition for forming a light absorption anisotropic layer is aligned.

The alignment film can be provided by methods such as a rubbing treatment performed on a film surface of an organic compound (preferably a polymer), oblique vapor deposition of an inorganic compound, formation of a layer having microgrooves, or accumulation of an organic compound (such as @-tricosanoic acid, dioctadecyl methylammonium chloride, or methyl stearylate) using a Langmuir-Blodgett method (LB film). Furthermore, there have been known alignment films having an aligning function imparted thereto by applying an electrical field, applying a magnetic field, or light irradiation. Among these, in the present invention, an alignment film formed by performing a rubbing treatment is preferable from the viewpoint of easily controlling the pretilt angle of the alignment film, and a photo-alignment film formed by irradiation with light is also preferable from the viewpoint of the uniformity of alignment.

The photo-alignment compound used for the photo-alignment film is described in many literatures. In the present invention, preferable examples thereof include azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B, aromatic ester compounds described in JP2002-229039A, maleimide and/or alkenyl-substituted nadimide compounds having photo-alignment units described in JP2002-265541A and JP2002-317013A, photocrosslinkable silane derivatives described in JP4205195B and JP4205198B, and photocrosslinkable polyimides, polyamides, and esters described in JP2003-520878A, JP2004-529220A, and JP4162850B. Azo compounds, photocrosslinkable polyimides, polyamides, and esters are more preferable.

Among these, a photosensitive compound having a photoreactive group which generates at least one of dimerization or isomerization by the action of light is preferably used as the photo-alignment compound.

In addition, examples of the photoreactive group include a group having a cinnamic acid (cinnamoyl) structure (skeleton), a group having a coumarin structure (skeleton), a group having a chalcone structure (skeleton), a group having a benzophenone structure (skeleton), and a group having an anthracene structure (skeleton). Among these groups, a group having a cinnamoyl structure or a group having a coumarin structure is preferable, and a group having a cinnamoyl structure is more preferable.

In addition, the above-described photosensitive compound having a photoreactive group may further have a crosslinkable group.

As the crosslinkable group, a thermally crosslinkable group which causes a curing reaction due to the action of heat and a photocrosslinkable group which causes a curing reaction due to the action of light are preferable, and the crosslinkable group may be a crosslinkable group which contains both a thermally crosslinkable group and a photocrosslinkable group.

Examples of the crosslinkable group include at least one selected from the group consisting of an epoxy group, an oxetanyl group, a group represented by —NH—CH₂—O—R(R represents a hydrogen atom or an alkyl group having 1 to 20 carbon atoms), a group having an ethylenically unsaturated double bond, and a block isocyanate group. Among these, an epoxy group, an oxetanyl group, or a group having an ethylenically unsaturated double bond is preferable.

A 3-membered cyclic ether group is also referred to as the epoxy group, and a 4-membered cyclic ether group is also referred to as the oxetanyl group.

Further, specific examples of the group having an ethylenically unsaturated double bond include a vinyl group, an allyl group, a styryl group, an acryloyl group, and a methacryloyl group. An acryloyl group or a methacryloyl group is preferable.

To a photo-alignment film formed from the above-described material, linearly polarized light or unpolarized light is applied to produce a photo-alignment film.

In the present specification, the “irradiation with linearly polarized light” and the “irradiation with unpolarized light” are operations for causing a photoreaction in the photo-alignment material. A wavelength of the light to be used varies depending on the photo-alignment material to be used, and is not particularly limited as long as the wavelength is required for the photoreaction. The peak wavelength of the light used for light irradiation is preferably 200 nm to 700 nm, and ultraviolet light having a peak wavelength of 400 nm or less is more preferable.

The light source used for light irradiation is a usually used light source, and examples thereof include lamps such as a tungsten lamp, a halogen lamp, a xenon lamp, a xenon flash lamp, a mercury lamp, a mercury/xenon lamp, and a carbon arc lamp, various lasers [for example, a semiconductor laser, a helium/neon laser, an argon ion laser, a helium/cadmium laser, and an YAG (yttrium/aluminum/garnet) laser], light emitting diodes, and cathode ray tubes.

As a method of obtaining linearly polarized light, a method using a polarizing plate (for example, an iodine polarizing plate, a dichroic dye polarizing plate, or a wire grid polarizing plate), a method using a prism-based element (for example, a Glan-Thompson prism) or a reflective polarizer for which a Brewster's angle is used, or a method using light emitted from a laser light source having polarized light can be employed. Only light having a necessary wavelength may be selectively applied by using a filter, a wavelength conversion element, or the like.

In a case where linearly polarized light is used as light for irradiation, a method of irradiating the alignment film with light from an upper surface or a rear surface in a direction vertical or oblique to the alignment film surface is employed. Although the incidence angle of the light varies depending on the photo-alignment material, the incidence angle is preferably 0° to 90° (vertical), and more preferably 40° to 90°.

In a case where unpolarized light is used, the alignment film is irradiated with unpolarized light from an oblique direction. The incidence angle of the light is preferably 10° to 80°, more preferably 20° to 60°, and still more preferably 30° to 50°.

The irradiation time is preferably 1 minute to 60 minutes, and more preferably 1 minute to 10 minutes.

In a case where patterning is required, a method of performing light irradiation using a photomask as many times as necessary for pattern formation, or a pattern writing method using laser beam scanning can be employed.

A feature of the light absorption anisotropic layer producing method according to the embodiment of the present invention is that the method has a light absorption anisotropic layer forming step of irradiating the above-described liquid crystal composition layer with ultraviolet rays in the air to form a light absorption anisotropic layer. It is considered that, by performing ultraviolet irradiation curing in the air, it is possible to form a hard film while alleviating the curing distortion, the disorder of the alignment that may occur during the curing can be suppressed, and as a result, the occurrence of haze can be suppressed.

Here, the ultraviolet irradiation method is not particularly limited as long as the ultraviolet irradiation is performed in the air in which oxygen is present, and the same method as the ultraviolet irradiation (exposure) known in the related art can be employed.

Since the durability of the light absorption anisotropic layer is improved, the light absorption anisotropic layer producing method according to the embodiment of the present invention preferably has a step of irradiating the light absorption anisotropic layer after the above-described light absorption anisotropic layer forming step with ultraviolet rays under nitrogen.

The light absorption anisotropic layer producing method according to the embodiment of the present invention preferably has a step (hereinafter, also abbreviated as “aligning step”) of aligning the liquid crystal component contained in the above-described liquid crystal composition layer before the above-described liquid crystal composition layer is irradiated with ultraviolet rays in the air in the above-described light absorption anisotropic layer forming step.

The aligning step is a step of aligning the liquid crystal component (particularly, dichroic substance) contained in the liquid crystal composition layer. In the aligning step, the dichroic substance is considered to be aligned along the liquid crystal compound aligned by the alignment film.

The aligning step may have a drying treatment. By the drying treatment, components such as a solvent can be removed from the coating film. The drying treatment may be performed by a method of leaving the coating film for a predetermined time at room temperature (for example, natural drying), or a heating and/or air blowing method.

The aligning step preferably has a heating treatment. Therefore, the dichroic substance contained in the coating film is further aligned, and the alignment degree of the dichroic substance is further increased.

From the viewpoint of production suitability and the like, the heating treatment is preferably performed at 10° C. to 250° C., and more preferably 25° C. to 190° C. Further, the heating time is preferably 1 to 300 seconds, and more preferably 1 to 60 seconds.

The aligning step may have a cooling treatment to be performed after the heating treatment. The cooling treatment is a treatment of cooling the coating film after heating to about room temperature (20° C. to 25° C.). Therefore, the alignment of the dichroic substance contained in the coating film is further fixed, and the alignment degree of the dichroic substance is further increased. The cooling method is not particularly limited, and the cooling can be performed by a known method.

### [Laminate]

A laminate according to the embodiment of the present invention is a laminate having the above-described light absorption anisotropic layer according to the embodiment of the present invention and a N/4 plate provided over the light absorption anisotropic layer.

The laminate according to the embodiment of the present invention preferably has a base material, and more preferably, the laminate is a laminate having the base material, the light absorption anisotropic layer, and the λ/4 plate in this order.

In addition, the laminate according to the embodiment of the present invention preferably has a barrier layer, and more preferably, the laminate is a laminate having the light absorption anisotropic layer, the barrier layer, and the λ/4 plate in this order.

In addition, the laminate according to the embodiment of the present invention may have an alignment film between the base material and the light absorption anisotropic layer.

Hereinafter, the constituent layers of the laminate according to the embodiment of the present invention will be described.

### [Base Material]

The base material can be selected depending on the applications of the light absorption anisotropic layer, and examples thereof include glass and a polymer film. The light transmittance of the base material is preferably 80% or more.

In a case where a polymer film is used as the base material, an optically isotropic polymer film is preferably used. As specific examples and preferred aspects of the polymer, the description in paragraph of JP2002-22942A can be applied. In addition, even a conventionally known polymer such as polycarbonate or polysulfone in which birefringence is likely to be developed can also be used by reducing the developability through the molecular modification described in WO2000/26705A.

### [Light Absorption Anisotropic Layer]

The light absorption anisotropic layer is as described above, and thus the description thereof will not be repeated.

### [λ/4 Plate]

The “λ/4 plate” is a plate having a λ/4 function, and specifically, a plate having a function of converting linearly polarized light of a specific wavelength into circularly polarized light (or circularly polarized light into linearly polarized light).

For example, in an aspect in which the λ/4 plate has a single layer structure, specific examples of the plate include a retardation film in which a light absorption anisotropic layer having a λ/4 function is provided on a stretched polymer film or a support. In an aspect in which the λ/4 plate has a multilayered structure, specific examples of the plate include a broadband λ/4 plate having a laminate of a λ/4 plate and a λ/2 plate.

The λ/4 plate and the light absorption anisotropic layer may be provided by coming into contact with each other, or another layer may be provided between the λ/4 plate and the light absorption anisotropic layer. Examples of such a layer include a pressure sensitive adhesive layer or an adhesive layer for ensuring the adhesiveness, and a barrier layer.

### [Barrier Layer]

In a case where the laminate according to the embodiment of the present invention has a barrier layer, the barrier layer is preferably provided between the light absorption anisotropic layer and the λ/4 plate. Further, in a case where the laminate includes a layer other than the barrier layer (for example, a pressure sensitive adhesive layer or an adhesive layer) between the light absorption anisotropic layer and the λ/4 plate, the barrier layer can be provided, for example, between the light absorption anisotropic layer and the layer other than the light absorption anisotropic layer.

The barrier layer is also referred to as a gas blocking layer (oxygen blocking layer), and has a function of protecting the light absorption anisotropic layer from gas such as oxygen in the atmosphere, the moisture, or the compound contained in an adjacent layer.

Regarding the barrier layer, the description in paragraphs [0014] to [0054] of JP2014-159124A, paragraphs [0042] to [0075] of JP2017-121721A, paragraphs [0045] to [0054] of JP2017-115076A, paragraphs [0010] to [0061] of JP2012-213938A, and paragraphs [0021] to [0031] of JP2005-169994A can be referred to.

### [Alignment Film]

The laminate according to the embodiment of the present invention may have an alignment film between the base material and the light absorption anisotropic layer.

Examples of the alignment film include the same alignment films as those in the description of the above-described light absorption anisotropic layer producing method according to the embodiment of the present invention.

### [Image Display Device]

An image display device according to the embodiment of the present invention has the above-described light absorption anisotropic layer according to the embodiment of the present invention or the above-described laminate according to the embodiment of the present invention.

The display element used in the image display device according to the embodiment of the present invention is not particularly limited, and examples thereof include a liquid crystal cell, an organic electroluminescence (hereinafter, abbreviated as “EL”) display panel, and a plasma display panel.

Among these, a liquid crystal cell or an organic EL display panel is preferable, and a liquid crystal cell is more preferable. That is, as the image display device according to the embodiment of the present invention, a liquid crystal display device using a liquid crystal cell as a display element, or an organic EL display device using an organic EL display panel as a display element is preferable, and a liquid crystal display device is more preferable.

### [Liquid Crystal Display Device]

A liquid crystal display device which is an example of the image display device according to the embodiment of the present invention preferably has an aspect in which it has the above-described light absorption anisotropic film and a liquid crystal cell. More preferably, the liquid crystal display device has the above-described laminate (but including no λ/4 plate) and a liquid crystal cell.

In the present invention, between the light absorption anisotropic layers (laminate) provided on both sides of the liquid crystal cell, it is preferable that the light absorption anisotropic layer (laminate) according to the embodiment of the present invention be used as a front-side polarizer and more preferable that the light absorption anisotropic layer (laminate) according to the embodiment of the present invention be used as a front-side polarizer and a rear-side polarizer.

Hereinafter, the liquid crystal cell constituting the liquid crystal display device will be described in detail.

### <Liquid Crystal Cell>

The liquid crystal cell used for the liquid crystal display device is preferably a vertical alignment (VA) mode, an optically compensated bend (OCB) mode, an in-plane-switching (IPS) mode, or a twisted nematic (TN) mode, but is not limited thereto.

In a TN mode liquid crystal cell, rod-like liquid crystal molecules are substantially horizontally aligned with no application of a voltage, and further twisted and aligned at 60° to 120°. The TN mode liquid crystal cell is most often used as a color thin film transistor (TFT) liquid crystal display device, and is described in many literatures.

In a VA mode liquid crystal cell, rod-like liquid crystal molecules are substantially vertically aligned with no application of a voltage. The VA mode liquid crystal cell includes: (1) a narrow-sense VA mode liquid crystal cell in which rod-like liquid crystal molecules are substantially vertically aligned when no voltage is applied, and substantially horizontally aligned when a voltage is applied (described in JP1990-176625A (JP-H2-176625A)), (2) a (MVA mode) liquid crystal cell (described in SID97, Digest of tech. Papers (proceedings) 28 (1997) 845) obtained by forming multi-domains in the VA mode in order to expand the viewing angle, (3) a (n-ASM mode) liquid crystal cell in a mode in which rod-like liquid crystal molecules are substantially vertically aligned when no voltage is applied and are twisted and multi-domain-aligned when a voltage is applied (described in Proceedings 58 and 59 (1998) of Japanese Liquid Crystal Conference), and (4) a SURVIVAL mode liquid crystal cell (disclosed in LCD International 98). In addition, the VA mode liquid crystal cell may be any of a patterned vertical alignment (PVA) type liquid crystal cell, an optical alignment type liquid crystal cell, or a polymer-sustained alignment (PSA) type liquid crystal cell. Details of these modes are described in JP2006-215326A and JP2008-538819A.

In an IPS mode liquid crystal cell, rod-like liquid crystal molecules are aligned substantially in parallel with respect to a substrate, and the liquid crystal molecules respond in a planar manner with the application of an electric field parallel to a substrate surface. In the IPS mode, black is displayed in a state in which no electric field is applied, and the absorption axes of a pair of upper and lower polarizing plates are orthogonal to each other. A method of improving a viewing angle by reducing light leakage at the time of black display in an oblique direction by using an optical compensation sheet is disclosed in JP1998-54982A (JP-H10-54982A), JP1999-202323A (JP-H11-202323A), JP1997-292522A (JP-H09-292522A), JP1999-133408A (JP-H11-133408A), JP1999-305217A (JP-H11-305217A), JP1998-307291A (JP-H10-307291A), and the like.

### [Organic EL Display Device]

An organic EL display device which is an example of the image display device according to the embodiment of the present invention preferably has an aspect in which it has a light absorption anisotropic layer, a λ/4 plate, and an organic EL display panel in this order from the viewing side.

More preferably, the organic EL display device has an aspect in which it has the above-described laminate having a λ/4 plate and an organic EL display panel in this order from the viewing side. In this case, the laminate is formed so that a base material, an alignment film provided as necessary, a light absorption anisotropic layer, a barrier layer provided as necessary, and a λ/4 plate are disposed in this order from the viewing side.

In addition, the organic EL display panel is a display panel formed of an organic EL element obtained by sandwiching an organic light emitting layer (organic electroluminescence layer) between electrodes (between a cathode and an anode). The configuration of the organic EL display panel is not particularly limited, and a known configuration is employed.

### EXAMPLES

Hereinafter, the present invention will be described in more detail on the basis of examples. Materials, used amounts, ratios, treatment contents, treatment procedures, and the like of the following examples are able to be suitably changed unless the changes cause deviance from the gist of the invention. Therefore, the range of the present invention will not be restrictively interpreted by the following examples.

### Example 1

### [Production of Photo-Alignment Film]

2 parts by mass of a photo-alignment polymer PA1 shown below and 98 parts by mass of o-xylene were mixed. The obtained mixture was stirred at 80° C. for 1 hour to obtain a composition for forming a photo-alignment film.

Next, coating was performed through a bar coating method, and drying was performed at 120° C. to obtain a dry coating.

Next, the dry coating was irradiated with polarized light UV to obtain a photo-alignment film. The polarized UV treatment was performed using a UV irradiation device (SPOT CURE SP-7; manufactured by Ushio Inc.) under the condition that the intensity measured at a wavelength of 365 nm was 100 mJ.

### Photo-Alignment Polymer PA1:

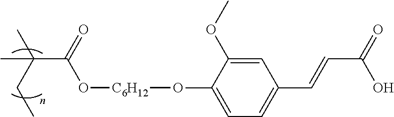

### [Production of Light Absorption Anisotropic Layer]

The following components were mixed and stirred at 80° C. for 1 hour, thereby obtaining a composition 1 for forming a light absorption anisotropic layer.

Composition 1 for Forming Light Absorption Anisotropic Layer

| | |
|---|---|
| Liquid crystal compound L1 shown below | 75 parts by mass |
| Liquid crystal compound L2 shown below | 25 parts by mass |
| Dichroic substance A1 shown below | 3 parts by mass |
| Dichroic substance A2 shown below | 3 parts by mass |
| Dichroic substance A3 shown below | 1 part by mass |
| Dichroic substance A4 shown below | 1 part by mass |
| 2-Dimethylamino-2-benzyl-1-(4- | 6 parts by mass |
| morpholinophenyl)butan-1-one(IRGACURE | |
| 369, manufactured by BASF SE) | |
| Polyacrylate compound (BYK-361N, | 1.2 parts by mass |
| manufactured by BYK-Chemie GmbH) | |
| o-xylene | 250 parts by mass |

Among these dichroic substances, the dichroic substance A3 and the dichroic substance A4 are dichroic substances having a maximal absorption wavelength in a wavelength range of 550 to 700 nm.

Next, the composition 1 for forming a light absorption anisotropic layer was applied to the photo-alignment film using a slot die coater to form a coating film. Furthermore, the coating film was transported through a ventilation drying furnace set to 110° C. for 2 minutes so that the solvent was removed, and the coating film was rapidly cooled to obtain a dry coating (liquid crystal composition layer).

Then, the dry coating was irradiated with ultraviolet light at 500 mJ/cm² (365 nm basis) using a high-pressure mercury lamp under an air atmosphere, and then further irradiated with ultraviolet light at 500 mJ/cm² (365 nm basis) using a high-pressure mercury lamp under a nitrogen atmosphere to cure the polymerizable liquid crystal contained in the dry coating, and thus a light absorption anisotropic layer was produced. The curing process in Example 1 is also abbreviated as “exposure in the air⇒exposure under N2”.

### Example 2

A light absorption anisotropic layer was produced in the same manner as in Example 1, except that in the curing process during the formation of the light absorption anisotropic layer, the curing was performed by applying ultraviolet light at 1,000 mJ/cm² (365 nm basis) using a high-pressure mercury lamp under an air atmosphere. The curing process in Example 2 is also abbreviated as “exposure in the air”.

### Example 3

A light absorption anisotropic layer was produced in the same manner as in Example 1, except that, as the composition 1 for forming a light absorption anisotropic layer, a composition in which 6 parts by mass of a monofunctional compound M1 shown below was further blended was used, and in the curing process during the formation of the light absorption anisotropic layer, the curing was performed by applying ultraviolet light at 1,000 mJ/cm² (365 nm basis) using a high-pressure mercury lamp under a nitrogen atmosphere. The curing process in Example 3 is also abbreviated as “exposure under N2”.

### Example 4

A light absorption anisotropic layer was produced in the same manner as in Example 3, except that, instead of the monofunctional compound M1 shown below, a monofunctional compound M2 shown below was used.

### Example 5

A light absorption anisotropic layer was produced in the same manner as in Example 1, except that, as the composition 1 for forming a light absorption anisotropic layer, a composition in which 6 parts by mass of the monofunctional compound M1 shown below was further blended was used.

### Example 6

A light absorption anisotropic layer was produced in the same manner as in Example 1, except that, as the composition 1 for forming a light absorption anisotropic layer, a composition in which the blending amount of the dichroic substance A3 was 2 parts by mass and the dichroic substance A4 was not blended was used.

### Examples 7 and 8

A light absorption anisotropic layer was produced in the same manner as in Example 1, except that, instead of the liquid crystal compounds L1 and L2, the liquid crystal compounds shown in Table 1 below were used.

### Comparative Example 1

A photo-alignment film was produced in the same manner as in Example 1.

Next, the same composition 1 for forming a light absorption anisotropic layer as that in Example 1 was prepared.

Next, the composition 1 for forming a light absorption anisotropic layer prepared as above was applied to the photo-alignment film produced as above by a bar coating method, and a light absorption anisotropic layer (polarizer layer) was produced by the method described in paragraph of JP2019-049758A.

### [Evaluation]

### (1) Diffraction Angle 2θ and I(φmax)/I(φmax−10)

For the produced light absorption anisotropic layer, an X-ray diffraction pattern was observed using an in-plane diffraction method in the above-described manner. Measurement results of diffraction angles 2θ of peaks P1 and P2 and calculation results of “I(max)/I(φmax-10)” on the left side of Expression (1) are shown in Table 1 below.

It was possible to confirm that the peak P2 observed in Examples 1 to 7 exhibited a peak intensity of 0.2 times or more the peak intensity I(φmax) of the peak P1.

### (2) Haze

Light scattering of the produced light absorption anisotropic layer in a case where fluorescent light passed through the light absorption anisotropic layer was observed. The haze performance was evaluated based on the following criteria. The evaluation results are shown in Table 1 below.

### <Evaluation Criteria>

AA: The layer is transparent, and no light scattering is visually recognized.
A: The light scattering is extremely slight, so it is not visually recognized.
B: Slight light scattering is visually confirmed, which is acceptable.
C: The light scattering is visually recognized, which is not acceptable.

### (3) Durability

A change in transmittance of the produced light absorption anisotropic layer in a case where the light absorption anisotropic layer was subjected to a lapse of time in an environment of 80° C. for 500 hours was observed. The durability was evaluated based on the following criteria. The results are shown in Table 1 below.

### <Evaluation Criteria>

A: The change in transmittance is hardly visually recognized.
B: The transmittance slightly changes, which is acceptable.
C: The change in transmittance is large, which is not acceptable.

### (4) Precipitability

The precipitability of the dichroic substance in a case where the composition for forming a light absorption anisotropic layer was subjected to a lapse of time at room temperature was evaluated based on the following criteria. The evaluation results are shown in Table 1 below. The evaluation result of C or higher is a practically acceptable level.

### <Evaluation Criteria>

A: No precipitation of the coloring agent occurs even after 7 days.
B: The occurrence of precipitation is not observed after 3 days, but the precipitation is observed after 7 days.
C: The occurrence of precipitation is not observed after 1 day, but the precipitation is observed after 3 days.
D: The precipitation is observed after 1 day.

TABLE 1

| | Light Absorption Anisotropic Layer | | | | | | | Evaluation Results | | | | |
|---|---|---|---|---|---|---|---|---|---|---|---|---|
| | Liquid | | | | | | | Diffraction | | | | |
| | Crystal | | Dichroic | | Monofunctional | | Curing | Angle 2θ | I(φmax)/ | | | |
| | Compound | | Substance | | Compound | | Process | (°) | I(<φmax − 10) | Haze | Durability | Precipitability |
| Example 1 | L1 | 75 | A1 | 3 | — | — | Exposure | 1.46 | 1.8 | A | A | A |
| | L2 | 25 | A2 | 3 | — | — | in the air | 20.11 | | | | |
| | — | — | A3 | 1 | — | — | ⇒ | — | | | | |
| | — | — | A4 | 1 | — | — | Exposure | — | | | | |
| | | | | | | | under N2 | | | | | |
| Example 2 | L1 | 75 | A1 | 3 | — | — | Exposure | 1.46 | 1.9 | A | B | A |
| | L2 | 25 | A2 | 3 | — | — | in the air | 20.13 | | | | |
| | — | — | A3 | 1 | — | — | | — | | | | |
| | | — | A4 | 1 | — | — | | — | | | | |
| Example 3 | L1 | 75 | A1 | 3 | M1 | 6 | Exposure | 1.45 | 1.7 | A | A | A |
| | L2 | 25 | A2 | 3 | — | — | under N2 | 19.30 | | | | |
| | — | — | A3 | 1 | — | — | | — | | | | |
| | — | — | A4 | 1 | — | — | | — | | | | |
| Example 4 | L1 | 75 | A1 | 3 | M2 | 6 | Exposure | 1.45 | 1.7 | A | A | A |
| | L2 | 25 | A2 | 3 | — | — | under N2 | 19.81 | | | | |
| | — | — | A3 | 1 | — | — | | — | | | | |
| | — | — | A4 | 1 | — | — | | — | | | | |
| Example 5 | L1 | 75 | A1 | 3 | M1 | 6 | Exposure | 1.45 | 2.0 | AA | A | A |
| | L2 | 25 | A2 | 3 | — | — | in the air | 19.30 | | | | |
| | — | — | A3 | 1 | — | — | ⇒ | — | | | | |
| | — | — | A4 | 1 | — | — | Exposure | — | | | | |
| | | | | | | | under N2 | | | | | |
| Example 6 | L1 | 75 | A1 | 3 | — | — | Exposure | 1.46 | 1.8 | A | A | C |
| | L2 | 25 | A2 | 3 | — | — | in the air | 20.18 | | | | |
| | — | — | A3 | 2 | — | — | ⇒ | — | | | | |
| | | | | | | | Exposure | | | | | |
| | | | | | | | under N2 | | | | | |
| Example 7 | L3 | 75 | A1 | 3 | — | — | Exposure | 1.78 | 1.8 | A | A | A |
| | L4 | 25 | A2 | 3 | — | — | in the air | 20.13 | | | | |
| | — | — | A3 | 1 | — | — | ⇒ | — | | | | |
| | — | — | A4 | 1 | — | — | Exposure | — | | | | |
| | | | | | | | under N2 | | | | | |
| Example 8 | L5 | 75 | A1 | 3 | — | — | Exposure | 1.44 | 1.6 | B | A | A |
| | L6 | 25 | A2 | 3 | — | — | in the air | — | | | | |
| | — | — | A3 | 1 | — | — | ⇒ | — | | | | |
| | — | — | A4 | 1 | — | — | Exposure | — | | | | |
| | | | | | | | under N2 | | | | | |
| Comparative | L1 | 75 | A1 | 3 | — | — | Exposure | 1.46 | 1.4 | C | A | C |
| Example 1 | L2 | 25 | A2 | 3 | — | — | under N2 | 20.20 | | | | |
| | — | — | A3 | 1 | — | — | | — | | | | |
| | — | — | A4 | 1 | — | — | | — | | | | |

The structures of the liquid crystal compounds, dichroic substances, and monofunctional compounds in Table 1 are shown below.

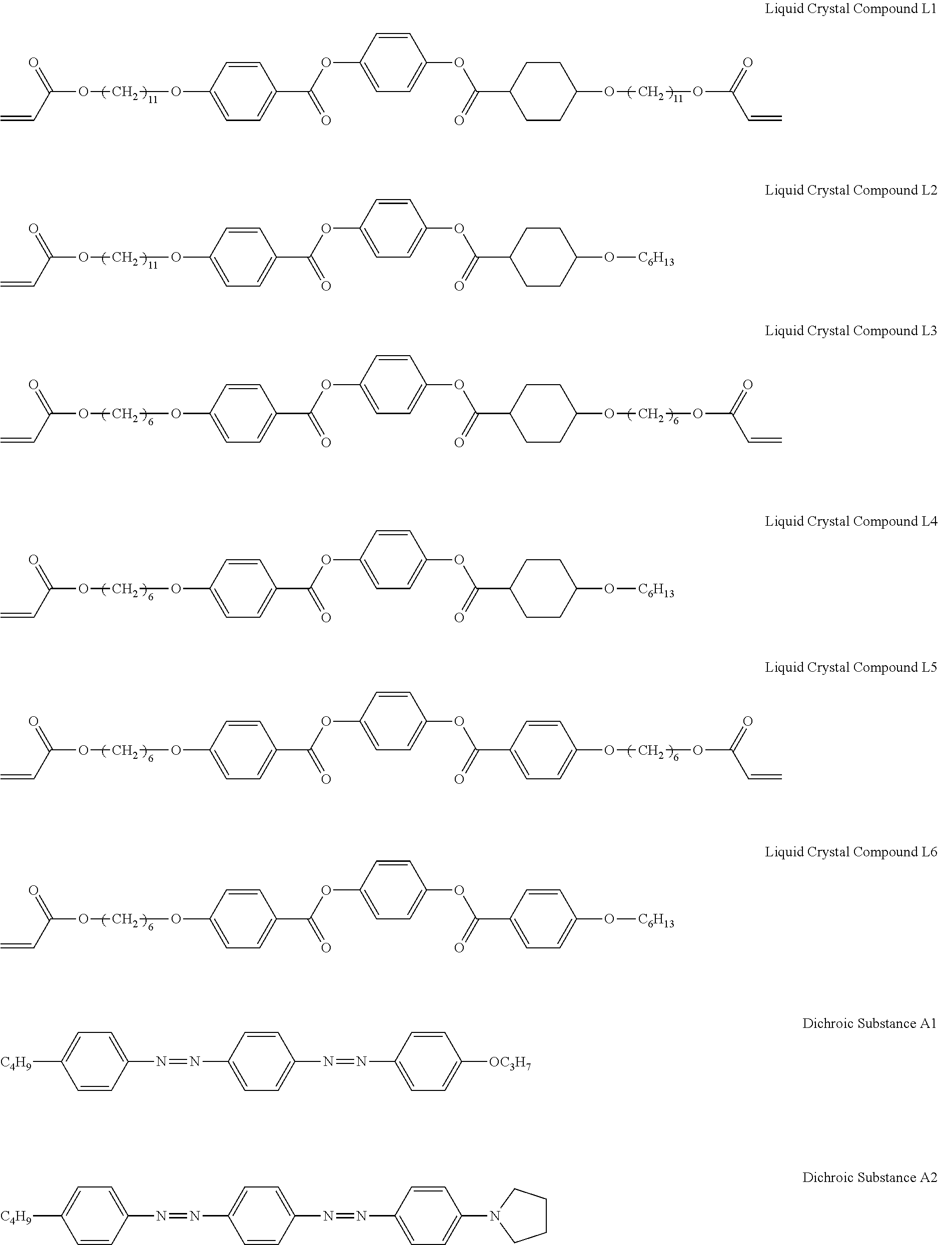

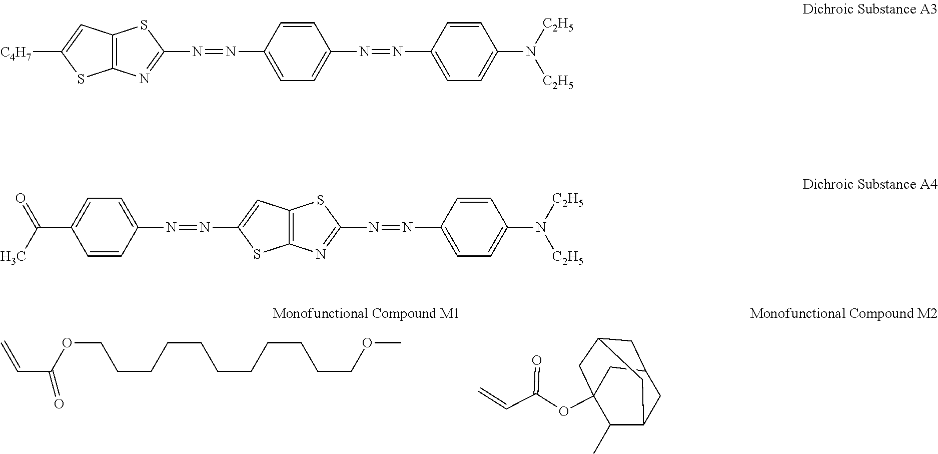

From the results shown in Table 1, it was found that, in a case where the value of I(φmax)/I(φmax−10) was less than 1.6, haze occurred, and the precipitability of the dichroic substance in a case where the composition for forming a light absorption anisotropic layer was subjected to a lapse of time at room temperature was also inferior (Comparative Example 1).

In contrast, it was found that, in a case where the value of I(φmax)/I(φmax−10) was 1.6 or more, the occurrence of haze was suppressed (Examples 1 to 8).

In particular, from the comparison between Example 1 and Example 2, it was found that the durability was improved in a case where the ultraviolet irradiation (exposure) in the air and the ultraviolet irradiation (exposure) under nitrogen were performed in this order in the curing process.

In addition, from the comparison between Example 1 and Example 5, it was found that, in a case where a monofunctional compound satisfying the relationship expressed by Expression (2) was blended, the occurrence of haze was further suppressed.

In addition, from the comparison between Example 1 and Example 6, it was found that, in a case where at least two dichroic substances having a maximal absorption wavelength in a wavelength range of 550 to 700 nm were used, it was possible to suppress the precipitability of the dichroic substance in a case where the composition for forming a light absorption anisotropic layer was subjected to a lapse of time.

In addition, from the comparison between Example 1 and Example 8, it was found that the occurrence of haze was further suppressed in a case where not only the peak P1 but also the peak P2 was observed.

### [Production of Positive A-Plate]

A coating liquid E1 for forming a photo-alignment film having the following composition was continuously applied with a wire bar, and then dried with hot air at 140° C. for 120 seconds. Subsequently, the resulting coating film was subjected to polarized ultraviolet irradiation (10 mJ/cm², using an ultra-high pressure mercury lamp), and thus a photo-alignment film E1 having a thickness of 0.2 μm was formed.

Coating Liquid E1 for Forming Photo-Alignment Film

| | |
|---|---|
| Polymer PA-2 shown below | 100.00 parts by mass |
| Acid generator PAG-1 shown below | 5.00 parts by mass |
| Acid generator CPI-110TF shown below | 0.005 parts by mass |
| Isopropyl alcohol | 16.50 parts by mass |
| Butyl acetate | 1072.00 parts by mass |
| Methyl ethyl ketone | 268.00 parts by mass |

Polymer PA-2

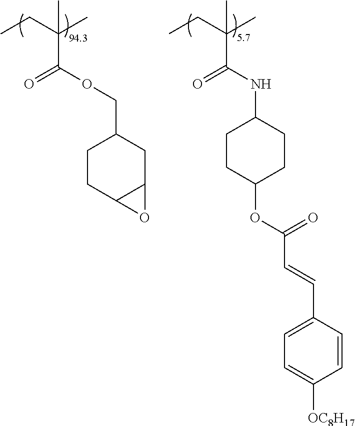

Acid Generator PAG-1

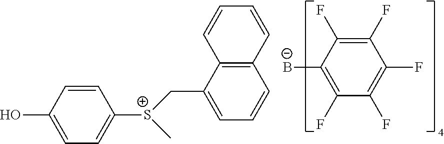

Acid Generator CPI-110TF

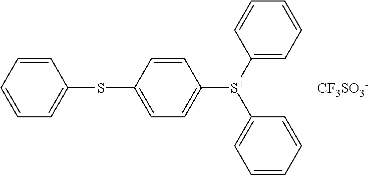

A composition F1 having the following composition was applied to the above-described photo-alignment film E1 using a bar coater. The coating film formed on the photo-alignment film E1 was heated to 120° C. with hot air, cooled to 60° C., irradiated with 100 mJ/cm² of ultraviolet rays having a wavelength of 365 nm using a high-pressure mercury lamp under a nitrogen atmosphere, and continuously irradiated with 500 mJ/cm² of ultraviolet rays while being heated to 120° C., so that the alignment of the liquid crystal compound was fixed and a positive A-plate F1 was thus produced.

The thickness of the positive A-plate F1 was 2.5 μm, and the Re (550) was 144 nm. In addition, the positive A-plate satisfied a relationship of “Re(450)≤Re(550)≤Re(650)”. Re(450)/Re (550) was 0.82.

Composition F1

| | |
|---|---|
| Polymerizable liquid crystal compound | 43.50 parts by mass |
| LA-1 shown below | |
| Polymerizable liquid crystal compound | 43.50 parts by mass |
| LA-2 shown below | |
| Polymerizable liquid crystal compound | 8.00 parts by mass |
| LA-3 shown below | |
| Polymerizable liquid crystal compound | 5.00 parts by mass |
| LA-4 shown below | |
| Polymerization initiator PI-1 shown below | 0.55 parts by mass |
| Leveling agent T-1 shown below | 0.20 parts by mass |
| Cyclopentanone | 235.00 parts by mass |

Polymerizable Liquid Crystal Compound LA-1 (tBu represents a tertiary butyl group)

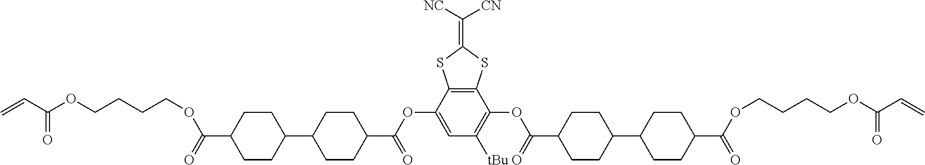 [SMILES: C=CC(=O)OCCCCOC(=O)C1CCC(C2CCC(C(=O)Oc3cc(C(C)(C)C)c(OC(=O)C4CCC(C5CCC(C(=O)OCCCCOC(=O)C=C)CC5)CC4)c4c3SC(=C(C#N)C#N)S4)CC2)CC1]

Polymerizable Liquid Crystal Compound LA-2

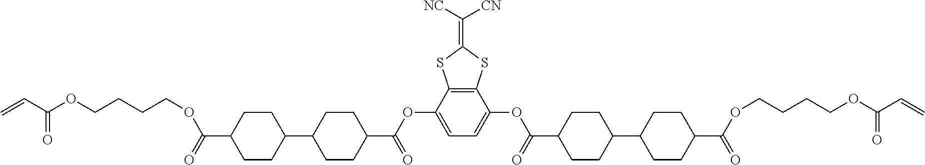 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c4c3SC(=C(C#N)C#N)S4)CC2)CC1]

Polymerizable Liquid Crystal Compound LA-3

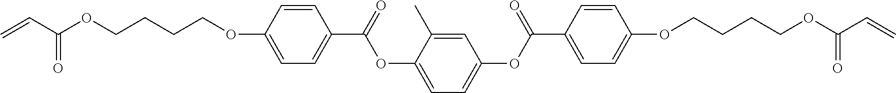 [SMILES: C=CC(=O)OCCCCOc1ccc(C(=O)Oc2ccc(OC(=O)c3ccc(OCCCCOC(=O)C=C)cc3)c(C)c2)cc1]

Polymerizable Liquid Crystal Compound LA-4 (Me represents a methyl group)

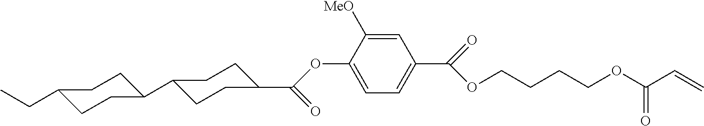 [SMILES: C=CC(=O)OCCCCOC(=O)c1ccc(OC(=O)C2CCC(C3CCC(CC)CC3)CC2)c(OC)c1]

Polymerization Initiator PI-1

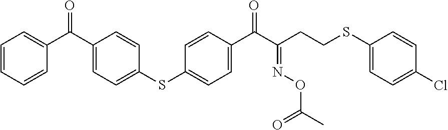 [SMILES: CC(=O)O/N=C(\CCSc1ccc(Cl)cc1)C(=O)c1ccc(Sc2ccc(C(=O)c3ccccc3)cc2)cc1]

Leveling Agent T-1

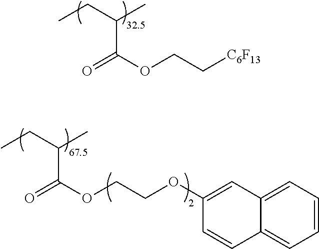

### [Production of TAC Film Having Positive C-Plate H1]

A coating liquid G1 for forming a photo-alignment film having the following composition was applied using a bar coater, and then dried with hot air at 60° C. for 60 seconds and further dried with hot air at 100° C. for 120 seconds to form a photo-alignment film G1.

Coating liquid G1 for forming photo-alignment film

| | |
|---|---|
| Polyvinyl alcohol (PVA103 | 2.4 parts by mass |
| manufactured by Kuraray Co., Ltd.) | |
| Isopropyl alcohol | 1.6 parts by mass |
| Methanol | 36 parts by mass |
| Water | 60 parts by mass |

A coating liquid H1 for forming a positive C-plate having the following composition was applied to the photo-alignment film G1. The obtained coating film was aged at 60° C. for 60 seconds, and then irradiated with 1,000 mJ/cm² of ultraviolet rays using a 70 mW/cm² air-cooled metal halide lamp (manufactured by Eye Graphics Co., Ltd.) in the air to fix the alignment state thereof, so that the liquid crystal compound was vertically aligned and a positive C-plate H1 having a thickness of 0.5 μm was thus produced.

Rth (550) of the obtained positive C-plate was-60 nm.

Coating Liquid H1 for Forming Positive C-Plate

| | | |
|---|---|---|
| Liquid crystal compound LC-1 shown | 80 | parts by mass |
| below | | |
| Liquid crystal compound LC-2 shown | 20 | parts by mass |
| below | | |
| Vertically aligned liquid crystal compound | 1 | part by mass |
| S01 | | |
| Ethylene oxide-modified trimethylolpropane | 8 | parts by mass |
| triacrylate (V#360, manufactured by Osaka | | |
| Organic Chemical Industry Ltd.) | | |
| IRGACURE 907 (manufactured by BASF | 3 | parts by mass |
| SE) | | |
| KAYACURE DETX (manufactured by | 1 | part by mass |
| Nippon Kayaku Co., Ltd.) | | |
| Compound B03 shown below | 0.4 | parts by mass |
| Methyl ethyl ketone | 170 | parts by mass |
| Cyclohexanone | 30 | parts by mass |

Liquid Crystal Compound LC-1

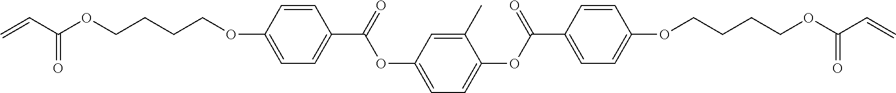 [SMILES: C=CC(=O)OCCCCOc1ccc(C(=O)Oc2ccc(OC(=O)c3ccc(OCCCCOC(=O)C=C)cc3)c(C)c2)cc1]

Liquid Crystal Compound LC-2

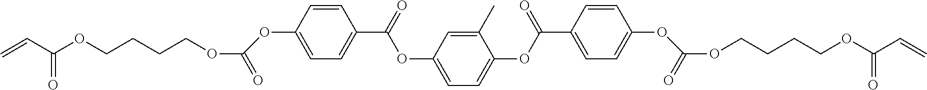 [SMILES: C=CC(=O)OCCCCOC(=O)Oc1ccc(C(=O)Oc2ccc(OC(=O)c3ccc(OC(=O)OCCCCOC(=O)C=C)cc3)c(C)c2)cc1]

Vertically Aligned Liquid Crystal Compound S01

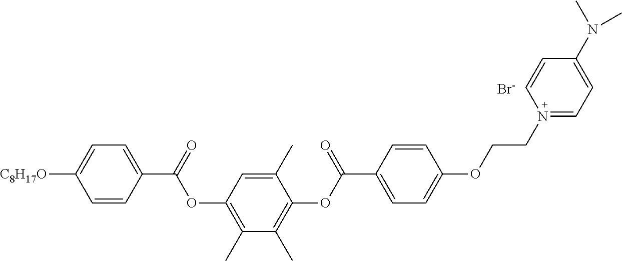

Compound B03

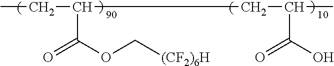

### [Production of Pressure Sensitive Adhesives N1 and N2]

Next, an acrylate-based polymer was prepared by the following procedure.

95 parts by mass of butyl acrylate and 5 parts by mass of acrylic acid were polymerized by a solution polymerization method in a reaction container equipped with a cooling pipe, a nitrogen introduction pipe, a thermometer, and a stirrer, thereby obtaining an acrylate-based polymer (NA1) with an average molecular weight of 2,000,000 and a molecular weight distribution (Mw/Mn) of 3.0.

Next, using the obtained acrylate-based polymer (NA1), an acrylate-based pressure sensitive adhesive was produced with the following composition. Each separate film which had been subjected to a surface treatment with a silicone-based release agent was coated with the composition using a die coater, dried under an environment of 90° C. for 1 minute, and irradiated with ultraviolet rays (UV) under the following conditions, thereby obtaining the following acrylate-based pressure sensitive adhesives N1 and N2 (pressure sensitive adhesive layers). The compositions and the film thicknesses of the acrylate-based pressure sensitive adhesives are shown below.

### <UV Irradiation Conditions>

Electrodeless lamp H bulb (Fusion Co., Ltd.)
Illuminance of 600 mW/cm², light dose of 150 mJ/cm²
The UV illuminance and the light dose were measured using “UVPF-36” (manufactured by Eye Graphics Co., Ltd.).

Acrylate-Based Pressure Sensitive Adhesive N1 (film thickness: 15 μm)

| | | |
|---|---|---|
| Acrylate-based polymer (NA1) | 100 | parts by mass |
| (A) Polyfunctional acrylate-based monomer | 11.1 | parts by mass |
| shown below | | |
| (B) Photopolymerization initiator shown below | 1.1 | parts by mass |
| (C) Isocyanate-based crosslinking agent | 1.0 | part by mass |
| shown below | | |
| (D) Silane coupling agent shown below | 0.2 | parts by mass |

Acrylate-Based Pressure Sensitive Adhesive
N2 (film thickness: 25 μm)

| | | |
|---|---|---|
| Acrylate-based polymer (NA1) | 100 | parts by mass |
| (C) Isocyanate-based crosslinking | 1.0 | part by mass |
| agent shown below | | |
| (D) Silane coupling agent shown | 0.2 | parts by mass |
| below | | |

(A) Polyfunctional acrylate-based monomer: tris(acryloyloxyethyl) isocyanurate, molecular weight=423, trifunctional type (manufactured by Toagosei Co., Ltd., trade name “ARONIX M-315”)

(B) Photopolymerization initiator: mixture of benzophenone and 1-hydroxycyclohexyl phenyl ketone at mass ratio of 1:1, “IRGACURE 500” manufactured by Ciba Specialty Chemicals Corp.

(C) Isocyanate-based crosslinking agent: trimethylolpropane-modified tolylene diisocyanate (“CORONATE L” manufactured by Nippon Polyurethane Industry Co., Ltd.)

(D) Silane coupling agent: 3-glycidoxypropyltrimethoxysilane (“KBM-403” manufactured by Shin-Etsu Chemical Co., Ltd.)

### [Production of UV Adhesive]

A UV adhesive composition having the following composition was prepared.

UV Adhesive Composition

| | |
|---|---|
| CEL2021P (manufactured by | 70 parts by mass |
| Daicel Corporation) | |
| 1,4-Butanediol diglycidyl ether | 20 parts by mass |
| 2-Ethylhexyl glycidyl ether | 10 parts by mass |
| CPI-100P | 2.25 parts by mass |

CPI-100P

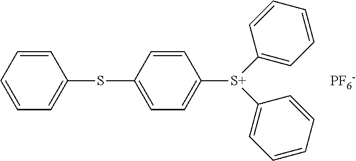

### [Production of Laminate CPAC1]

The positive A-plate F1 and the positive C-plate H1 were bonded to each other by UV irradiation at 600 mJ/cm² using the UV adhesive composition. The thickness of the UV adhesive layer was 3 μm. A corona treatment was performed on the surfaces bonded to each other with the UV adhesive. Next, the support of the photo-alignment film E1 on the positive A-plate F1 side was removed to provide a retardation plate AC1.

The light absorption anisotropic layer produced in Example 1 was bonded to a support side of a low-reflection surface film CV-LC5 (manufactured by FUJIFILM Corporation) using the pressure sensitive adhesive N1. Next, the support included in the light absorption anisotropic layer produced in Example 1 was removed. The surface from which the support had been removed and the positive A-plate F1 side of the retardation plate AC1 were bonded to each other using the pressure sensitive adhesive N1. Next, the support included in the retardation plate AC1 on the positive C-plate H1 side was removed to produce a laminate CPAC1. In this case, the bonding was carried out so that an angle formed between the absorption axis of the light absorption anisotropic film C1 included in the laminate CPAC1 and the slow axis of the positive A-plate F1 was 45°. Further, the laminate CPAC1 has a layer configuration of the low-reflection surface film CV-LC5, the pressure sensitive adhesive layer N1, the oxygen blocking layer D1, the light absorption anisotropic film C1, the photo-alignment film B1, the pressure sensitive adhesive layer N1, the positive A-plate F1, the UV adhesive layer, and the positive C-plate H1.

GALAXY S5 (manufactured by Samsung Electronics Co., Ltd.) equipped with an organic EL panel (organic EL display element) was disassembled, a touch panel provided with a circularly polarizing plate was peeled off from the organic EL display device, and a circularly polarizing plate was further peeled off from the touch panel, so that the organic EL display element, the touch panel, and the circularly polarizing plate were isolated from each other. Subsequently, the isolated touch panel was bonded to the organic EL display element again, and the laminate CPAC1 on the positive C-plate 1 side, which had been produced as above, was bonded onto the touch panel so that air did not enter, thereby producing an image display device.

In a case where an image was displayed using the image display device produced as above, light scattering from both the front and an oblique direction was not visually recognized.

### Explanation of References

1: light absorption anisotropic layer
2: liquid crystal compound
3: diffraction plane
4: incident X-ray
5: reflected X-ray
6: diffracted X-ray

What is claimed is:

1. A light absorption anisotropic layer containing a dichroic substance and a liquid crystal compound,
wherein, in a case where, in an X-ray diffraction pattern measurement using an in-plane diffraction method with X-ray irradiation on the light absorption anisotropic layer, diffracted X-rays are measured in a measurement region shown below to determine a diffraction angle 2θmax and a rotation angle φmax at which a peak intensity is maximized, a peak intensity of diffracted X-rays at the diffraction angle 2θmax and the rotation angle φmax is represented by I(max), and a peak intensity of diffracted X-rays at the diffraction angle 2θmax and the rotation angle φmax−10° is represented by I(φmax-10), a relationship expressed by Expression (1) is satisfied,
Measurement Region:
Rotation angle q in in-plane direction of light absorption anisotropic layer: 0° to 180°
Diffraction angle 2θ:0° to 10°
$$I ( φ max ) / I ( φmax - 10 ) \geq 1.6 . \qquad Expression ( 1 )$$

2. The light absorption anisotropic layer according to claim 1,
wherein, in a case where the light absorption anisotropic layer is fixed at a position of the rotation angle φmax−90° and the diffraction angle 2θ is measured in a range of more than 10° and 30° or less, a peak of diffracted X-rays showing a peak intensity of I(φmax)×0.2 times or more is observed.

3. The light absorption anisotropic layer according to claim 1,
wherein the light absorption anisotropic layer is formed using a liquid crystal composition containing a dichroic substance, a liquid crystal compound, and a monofunctional compound, and
a molecular length D1 (Å) of the liquid crystal compound in a major axis direction and a molecular length D2 (Å) of the monofunctional compound in a major axis direction satisfy a relationship expressed by Expression (2),
$$0.2 \times D 1 \leq D 2 \leq 0.45 \times D 1. \qquad Expression ( 2 )$$

4. The light absorption anisotropic layer according to claim 1,
wherein the dichroic substance includes at least two dichroic substances having a maximal absorption wavelength in a wavelength range of 550 to 700 nm.

5. A light absorption anisotropic layer producing method of producing the light absorption anisotropic layer according to claim 1, the method comprising:
a light absorption anisotropic layer forming step of irradiating a liquid crystal composition layer containing a dichroic substance, a liquid crystal compound, and a monofunctional compound with ultraviolet rays in air to form a light absorption anisotropic layer.

6. The light absorption anisotropic layer producing method according to claim 5,
wherein the method has a step of irradiating the light absorption anisotropic layer after the light absorption anisotropic layer forming step with ultraviolet rays under nitrogen.

7. A laminate comprising:
the light absorption anisotropic layer according to claim 1; and
a λ/4 plate provided over the light absorption anisotropic layer.

8. An image display device comprising:
the light absorption anisotropic layer according to claim 1.

9. The light absorption anisotropic layer according to claim 2,
wherein the light absorption anisotropic layer is formed using a liquid crystal composition containing a dichroic substance, a liquid crystal compound, and a monofunctional compound, and
a molecular length D1 (Å) of the liquid crystal compound in a major axis direction and a molecular length D2 (Å) of the monofunctional compound in a major axis direction satisfy a relationship expressed by Expression (2),
$$0.2 \times D 1 \leq D 2 \leq 0.45 \times D 1. \qquad Expression ( 2 )$$

10. The light absorption anisotropic layer according to claim 2,
wherein the dichroic substance includes at least two dichroic substances having a maximal absorption wavelength in a wavelength range of 550 to 700 nm.

11. A light absorption anisotropic layer producing method of producing the light absorption anisotropic layer according to claim 2, the method comprising:
a light absorption anisotropic layer forming step of irradiating a liquid crystal composition layer containing a dichroic substance, a liquid crystal compound, and a monofunctional compound with ultraviolet rays in air to form a light absorption anisotropic layer.

12. The light absorption anisotropic layer producing method according to claim 11,
wherein the method has a step of irradiating the light absorption anisotropic layer after the light absorption anisotropic layer forming step with ultraviolet rays under nitrogen.

13. A laminate comprising:
the light absorption anisotropic layer according to claim 2; and
a λ/4 plate provided over the light absorption anisotropic layer.

14. An image display device comprising:
the light absorption anisotropic layer according to claim 2.

15. The light absorption anisotropic layer according to claim 3,
wherein the dichroic substance includes at least two dichroic substances having a maximal absorption wavelength in a wavelength range of 550 to 700 nm.

16. A light absorption anisotropic layer producing method of producing the light absorption anisotropic layer according to claim 3, the method comprising:
a light absorption anisotropic layer forming step of irradiating a liquid crystal composition layer containing a dichroic substance, a liquid crystal compound, and a monofunctional compound with ultraviolet rays in air to form a light absorption anisotropic layer.

17. The light absorption anisotropic layer producing method according to claim 16,
wherein the method has a step of irradiating the light absorption anisotropic layer after the light absorption anisotropic layer forming step with ultraviolet rays under nitrogen.

18. A laminate comprising:
the light absorption anisotropic layer according to claim 3; and
a λ/4 plate provided over the light absorption anisotropic layer.

19. An image display device comprising:
the light absorption anisotropic layer according to claim 3.
